(19) United States
(12) Patent Application Publication
(10) Pub. No.: US 2009/0322693 A1
(43) Pub. Date: Dec. 31, 2009

(54) DEVICE INCLUDING DISPLAY AND INPUT FUNCTIONS AND METHOD

(75) Inventor: Akihiro SASAKURA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/476,410

(22) Filed: Jun. 2, 2009

(30) Foreign Application Priority Data
Jun. 30, 2008 (JP) 2008-171415

(51) Int. Cl. G06F 3/041

(52) U.S. Cl. 345/173

(57) ABSTRACT

To enable an input unit inputting information showing a contact position when in a first mode to be used as a pointing device inputting information showing a movement quantity of the contact position when in a second mode. Information is displayed on a display unit, a touch on a detection surface disposed in superposition on a display area of the display unit is detected, and a signal based on a contact status is inputted to a processing unit from an input unit, information given from the input unit is set as information showing a contact position when in a first mode and as information showing a movement quantity of the contact position when in a second mode, the signal is switched over.

### CROSS-REFERENCE OF RELATED APPLICATION

This application is based upon and claims the benefit of priority of the prior Japanese Patent Application No. 2008-171415, filed on Jun. 30, 2008, the entire contents of which are incorporated herein by reference.

### FIELD

Disclosed is a technology of inputting to an information processing device (computer).

### BACKGROUND

A conventional mobile information terminal is utilized in a way that uses, when connecting with an external display, a original pointing device of the mobile information terminal as it is, or connects a mouse to the mobile information terminal and a port replicator.

Further, the related prior arts are, e.g., technologies disclosed in the following Patent documents.

[Patent Document 1]

Japanese Patent Laid-Open Publication No. 2005-181424

[Patent Document 2]

Japanese Patent Laid-Open Publication No. H10-240491

### SUMMARY

The pointing device of the mobile information terminal is designed mainly for operability when utilizing mobile equipment but has a problem of being hard to handle in the case of using the standard pointing device of the mobile information terminal when connecting with the external display.

Moreover, when utilized by connecting the mouse etc to the mobile information terminal and the port replicator, there is a necessity for carrying the mouse etc, thus, a problem is that portability of the mobile equipment declines.

For solving the problems given above, a device disclosed herein comprises: a display unit displaying information; an input unit detecting a touch on a detection surface disposed in superposition on a display area of the display unit, and inputting a signal based on a contact status to a processing unit; and a switching module setting information given from the input unit as information showing a contact position when in a first mode and as information showing a movement quantity of the contact position when in a second mode, and switching over the signal transmitted to the processing unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a schematic view of an information processing device according to a first embodiment.

FIG. 2 is a schematic diagram of the information processing device according to the first embodiment.

FIG. 3 is an explanatory diagram of a switching method in the first embodiment.

FIG. 4 is a diagram showing a display example according to a second embodiment.

FIG. 5 is an explanatory diagram showing a switching method according to the second embodiment.

### DESCRIPTION OF EMBODIMENT(S)

A best mode for carrying out the present invention will hereinafter be described with reference to the drawings. Configurations in the following embodiments are exemplifications, and the present invention is not limited to the configurations in the embodiments.

### First Embodiment

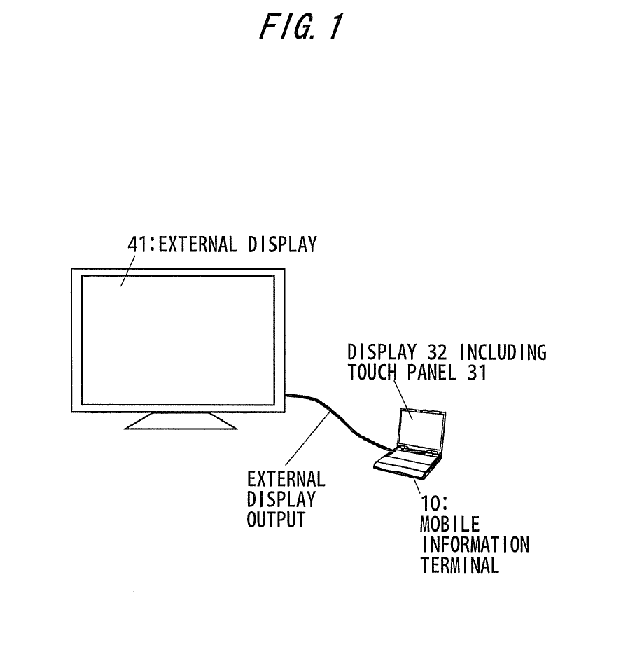

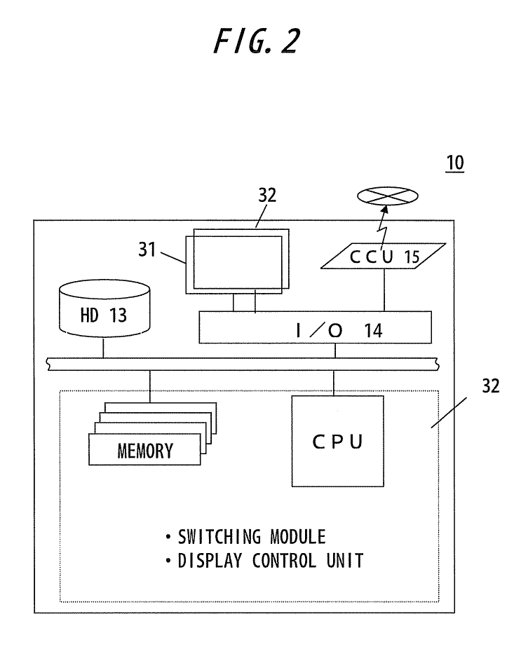

FIGS. 1 and 2 are a schematic view and a schematic diagram of an information processing device according to a first embodiment.

An information processing device 10 in the first embodiment is a so-called mobile information terminal including, within a small-sized housing, an arithmetic processing unit 12 constructed of a CPU (Central Processing Unit), a main memory, etc, a storage unit (hard disk) 13 stored with data and software for the arithmetic process, an input/output (I/O) port 14, a communication control unit (CCU) 15 and so on.

Input devices such as a keyboard, a touch panel (input unit) 31 and a CD-ROM drive and output devices such as a display unit 32 and a printer are properly connected to the I/O port 14.

Further, the I/O port 14 is provided with an output connector (connecting unit) 33 for connecting an external display 41.

The touch panel 31 detects a touch on a detection surface laid out in superposition on a display area of the display unit 32, and inputs a signal based on a touch status to the conversion processing unit 12.

The CCU 15 performs communications with other computer via a network.

The storage unit 13 is preinstalled with an operating system (OS) and a program.

The arithmetic processing unit 12 functions also as a switching module and a display control unit by properly reading the OS and an application program from the storage unit 13, executing the OS and the application program, performing the arithmetic process about information inputted from the I/O port 14 and the CCU 15 and information read from the storage unit 13.

The switching module switches over a signal transmitted to the arithmetic processing unit 12 in a way that sets the information given from the touch panel 31 as information indicating the position touched by a user when in a first mode and as information showing a quantity of shift of the touch position when in a second mode.

Further, the display control unit stops the display of the display unit 32 when in the second mode.

Thus, the mobile information terminal 10 according to the first embodiment, which includes the display unit 32 provided with the touch panel 31 and the external display output (output connector) 33, connects with the external display 41 having a large screen as the necessity may arise, and can output an operation screen to the external display 41.

On this occasion, the user can use the touch panel 31 in two types of operation modes. One mode is a touch panel mode (first mode) of displaying the same or a different operation screen on the display unit 32 of the mobile information terminal 10 and on the external display 41 in the same way as by the conventional method, and using the external display 41 as the touch panel in the same way as when not connected.

Another mode is a touch pad mode (second mode) of displaying the operation screen of the mobile information terminal 10 only on the external display 41, and using the touch panel 31 of the mobile information terminal 10 as a pointing device for the operation screen displayed on the external display 41.

If preset so as to switch over to the touch pad mode when the user connects the mobile information terminal 10 to the external display 41, the switching module, when detecting that the external display 41 is connected to the output connector 33, automatically switches over the mode to the touch pad mode. Then, the switching module, when detecting that the external display 41 is disconnected from the output connector 33, automatically switches over the mode to the touch panel mode. Incidentally, the detection that the external display 41 is connected or disconnected involves using the signal related to the connection of the external display 41. For example, the connection is detected when DDC (Display Data Channel) acquires EDID (Extended Display Identification Data) from the external display 41 by use of a signal line within a display cable, SDA (Serial Data) and SCL (Serial Clock). Further, the signal line, the SDA and the SCL get into NC (No Contact), in which case it is detected that the external display 41 is disconnected.

The switchover of the mode may also be, without being limited to the automatic switchover scheme conducted corresponding to the connected status of the external display, done in such a way that the user makes selection by using a predetermined key (a hot key and a function key) or may also make the selection from properties of the screen of the display 32.

Thus, the touch panel 31 is employed in the touch panel mode and in the touch pad mode, and hence the first embodiment provides a driver for the touch panel mode and a driver for the touch pad mode. Then, the switching module is realized by resident software that monitors the mode switchover, and the driver for user is selected corresponding to the detected mode switchover.

Note that a method of implementing the switching module and the driver is not limited to what has been described above, and it is sufficient that the touch panel 31 is utilized with the switchover to the touch panel mode and the touch pad mode.

Further, the switching module may notify the display control unit of the switchover to the second mode, and the display control unit may get the display on the operation screen disappeared. Through this operation, the user can clearly understand that the present operation mode is the touch pad mode. Note that if the display unit 32 is a liquid crystal display, a backlight may be simply switched off while letting the display on the liquid crystal unit be as it is. When the switching module notifies the display control unit that the external display 41 is disconnected from the output connector 33, the display control unit resumes the display on the operation screen of the display unit 32.

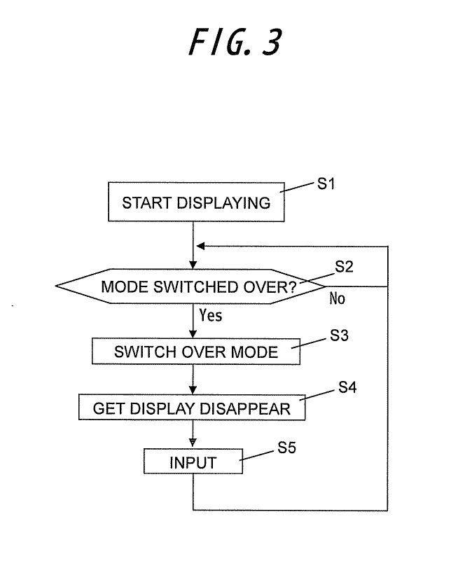

FIG. 3 is an explanatory diagram of a method by which the mobile information terminal 10 switches over the mode based on the program.

To begin with, when the mobile information terminal 10 is started up, the display control unit starts displaying on the display unit 32 (step 1, which will hereinafter be abbreviated also such as S1).

The switching module monitors the connection of the external display and the mode switchover such as selecting the predetermined key (S2).

In the case of detecting the mode switchover, the switching module switches over the mode (S3). When shifting to the touch pad mode, the switching module stops the touch panel driver, and makes the touch pad driver usable. Further, when shifting to the touch panel mode, the switching module stops the touch pad driver, and makes the touch panel driver usable.

Moreover, the display control unit, when shifting to the touch pad mode, gets the display on the display unit 32 disappeared (S4).

Then, when the user touches and operates the touch panel 31, the signal based on this operation is inputted to the arithmetic processing unit 12 via the usable driver (S5). What is inputted is, for example, information showing a movement quantity given when the user touches the touch panel 31 with a finger in the touch pad mode and moves the finger along on the detection surface, the information showing the movement quantity is inputted. Note that the information showing the movement quantity contains a moving direction, a moving velocity and a moving distance. The arithmetic processing unit 12 executes a process of moving a cursor etc corresponding to the information showing this movement quantity.

Further, the signal based on the contact status contains information showing that the user taps on the touch panel 31. For instance, processes assigned to a button and an icon can be executed in a way that adjusts the cursor to the button and the icon and clicks the button and the icon by tapping once or twice.

As discussed above, according to the first embodiment, it is feasible to provide a technology which enables an input unit inputting the information showing the contact position when in a first mode to be used as the pointing device inputting the information showing the movement quantity of the contact position when in the second mode.

Further, according to the first embodiment, when connecting with the external display 41, the touch panel mounted therein can be used as the touch pad, thereby eliminating a necessity for carrying the device such as the mouse or preparing a plurality of these devices and improving the usability.

Moreover, the switching module detects the connection with the external auxiliary display, and the operation mode is automatically switched over to the touch panel mode or the touch pad mode. Further, the display on the display unit with the touch panel function automatically disappears, and therefore the user can smoothly utilize the touch pad when connecting with the external display without being aware of anything particular.

### Second Embodiment

A second embodiment is different from the first embodiment discussed above in terms of a point that the touch panel can be utilized as an operation unit when in the touch pad mode. Note that other configurations are the same, and hence the same components are marked with the same numerals and symbols, while their repetitive explanations are omitted.

The display control unit displays a predetermined control image on the display unit when in the touch pad mode.

Then, the arithmetic processing unit 12, if an input for selecting the control image is done via the touch panel 31, executes a process assigned to the control image.

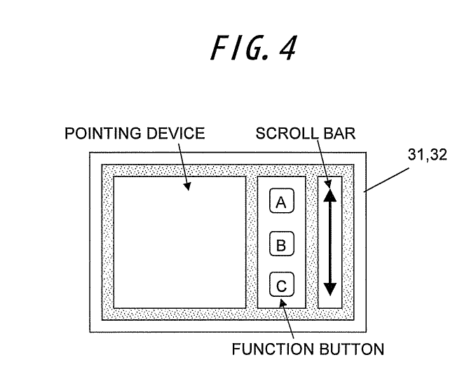

FIG. 4 shows one example. The example illustrates, from the right side, a scroll bar for scrolling window display by tracing in a vertical direction, function buttons touched to startup, switch over the applications and so on, and a pointing area functioning as the pointing device similar to the normal touch pad, into which the area is divided and to which the functions are assigned. For others, a variety of functions such as a slide bar for changing a speed of the cursor can be allocated. Moreover, the functions are displayed on the display with the touch panel function, whereby the user can surely operate the respective functions.

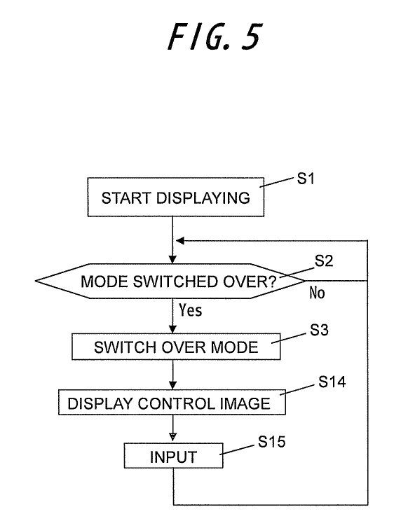

FIG. 5 is an explanatory diagram showing a mode switching method in the second embodiment.

In the same way as described above, when the mode is switched over (S1-3), the display control unit displays the control image such as the function buttons and the scroll bar as in FIG. 4 (S14).

Then, when the user touches and operates the touch panel 31, the signal based on this operation is inputted to the arithmetic processing unit 12 via the usable driver. At this time, if operated for the control image in the touch pad mode, the arithmetic processing unit 12 executes the process assigned to this control image (S15).

According to the second embodiment, the user can use the mobile information terminal 10 with the high-operability interface more simply, thereby enabling the usability to be improved.

<Others>

The recording medium readable by the computer connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc are given as those demountable from the computer.

Further, a hard disc, a ROM (Read-Only Memory), etc. are given as the recording mediums fixed within the computer.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A device comprising:
a display unit displaying information;
an input unit configured to detect at least a touch on a detection surface disposed in superposition on a display area of the display unit, and inputting a signal based on a contact status to a processing unit; and
a switching module configured to switch over the signal transmitted to the processing unit based on a first mode or a second mode, wherein the signal inputted from the input unit is regarded in a first mode as the signal showing a contact position, and in a second mode, regarded as the signal showing a movement quantity of the contact position.

2. The device according to claim 1, further comprising a connecting unit connecting an external display,
wherein when the external display is connected to the connecting unit, the switching module switches over the signal to be sent in the second mode.

3. The device according to claim 1, further comprising a display control unit stopping the display on the display unit when in the second mode.

4. The device according to claim 1, further comprising:
a display control unit displaying a predetermined control image on the display unit when in the second mode; and
a processing unit conducting control assigned to the control image when the input unit does an input for selecting the control image.

5. A method by which a computer executes:
displaying information on a display unit;
detecting at least a touch on a detection surface disposed in superposition on a display area of the display unit, and inputting a signal based on a contact status to a processing unit; and
setting the signal given from the input unit as the signal showing a contact position when in a first mode and as the signal showing a movement quantity of the contact position when in a second mode, and switching over the signal transmitted to the processing unit.

6. The method according to claim 5, wherein when the external display is connected, the signal is switched over to the signal showing the movement quantity of the contact position when in the second mode.

7. The method according to claim 5, wherein the computer stopping the display on the display unit when in the second mode.

8. The method according to claim 5, wherein the computer executes:
displaying a predetermined control image on the display unit when in the second mode; and
conducting control assigned to the control image when the input unit does an input for selecting the control image.

9. A storage medium readable by a computer, storing a program operated by the computer and making the computer execute:
displaying information on a display unit;
detecting at least a touch on a detection surface disposed in superposition on a display area of the display unit, and inputting a signal based on a contact status to a processing unit; and
setting the signal given from the input unit as the signal showing a contact position when in a first mode and as the signal showing a movement quantity of the contact position when in a second mode, and switching over the signal transmitted to the processing unit.

10. The storage medium according to claim 9, wherein when the external display is connected, the signal is switched over to the signal showing the movement quantity of the contact position when in the second mode.

11. The storage medium according to claim 9, wherein the computer stopping the display on the display unit when in the second mode.

12. The storage medium according to claim 9, wherein the computer executes:
displaying a predetermined control image on the display unit when in the second mode; and
conducting control assigned to the control image when the input unit does an input for selecting the control image.
